(19) United States
(12) Patent Application Publication
(10) Pub. No.: US 2007/0077925 A1
(43) Pub. Date: Apr. 5, 2007

(54) Mobile terminal with data delete function

(75) Inventor: Yoshitaka Hiyama, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/321,810

(22) Filed: Dec. 29, 2005

(30) Foreign Application Priority Data
Sep. 30, 2005 (JP) 2005-286150

(51) Int. Cl. H04Q 7/22

(52) U.S. Cl. 455/420; 455/414.1

(57) ABSTRACT

To prevent information leakage due to the loss of a mobile terminal, when various delete conditions that are set in advance in the mobile terminal are satisfied, data is deleted by control performed by the mobile terminal itself. By allowing the mobile terminal to perform control of deleting data instead of allowing an outside system such as a network to perform the control of deleting the data, it is possible to reduce the risk that the information leaks out to a third person when the network cannot perform the control or during a period of time between when the mobile terminal is lost and when the loss of the mobile terminal is noticed. Moreover, by saving the data to be deleted in another computer device by uploading the data onto, for example, a server on the network so that the data can be recovered, leakage of the information from the mobile terminal can be prevented without hampering the convenience for the user.

### CROSS-REFERENCE TO RELATED APPLICATIONS

This application is based upon and claims the benefit of priority from the prior Japanese Patent Application No. 2005-286150, filed on Sep. 30, 2005, the entire contents of which are incorporated herein by reference.

### BACKGROUND OF THE INVENTION

1. Field of the Invention

The present invention relates to a method for preventing the information leaking out from a mobile terminal that has been lost due to displacement or theft. Particularly, the present invention relates to a mobile terminal capable of preventing leakage of the information stored inside the mobile terminal.

2. Description of the Related Art

Recently, multifunctional and large-volume mobile terminals have developed. Especially these mobile terminals have storage devices stored therein, thus, in case of loss, the information that should not be leaked out, such as the address book, mails, and transmission/reception history, might often leak out. Since such information contains personal information of other individuals, leakage of such personal information has been a social problem.

Conventionally, an individual authentication check function of a mobile terminal has prevented the information such as the address book and transmission/reception history from leaking out from the mobile telephone due to displacement and theft. Further, there are various methods, such as use of a personal identification number, fingerprint authentication, and face authentication, that have been proposed as the individual authentication check function. However, it is troublesome to perform an authentication operation every time when actually using a mobile telephone. For this reason, such authentication check function is usually not set up and used.

Furthermore, the more the number of digits of a personal identification number, the higher the security, but an input operation of the keys has to be performed frequently. Although key input becomes easy if the number of the digits is less, the risk that security is breached is high. A function for controlling the mobile terminal from the network side after being lost and disabling the operation of the terminal (remote lock function), and a function for deleting the data stored therein have been realized as the service.

Moreover, as a method of securing deleting the information stored in a lost mobile telephone, Japanese Patent Application Laid-Open No. 2001-292222 discloses a method of deleting the private information such as the phone book information by controlling the mobile telephone at the mobile communication network side that includes a telephone switchboard and a base station. However, if the control on the network side is difficult (because the terminal is outside the range of the base station, or the power of the terminal is off), it is impossible to delete the information.

Japanese Patent Application Laid-Open No. 2003-250184 discloses means for uploading the data before deleting it. This uploading means is controlled at the network side in the same way as described above. Further, Japanese Patent Application Laid-Open No. 2002-369251 is not useful at all in the case in which a finder of a lost mobile telephone refers to the information inside the mobile terminal only, because the lost mobile telephone is remotely locked from the network side once the lost mobile telephone is registered as a lost terminal after a call request is found on the lost mobile telephone.

As described above, in the case in which remote lock and deleting the information are performed from the network side by controlling the mobile terminal, a third person who has found the mobile telephone can refer to the information in the terminal during a period of time between when the mobile terminal (mobile telephone) was found and when deleting the information.

Therefore, an object of the present invention is to provide a mobile terminal that can prevent leakage of the information when the terminal is lost or the like.

Another object of the present invention is to provide a mobile terminal which can prevent leakage of the information when the terminal is lost or the like, without-hampering the convenience in ordinary use of the terminal.

### SUMMARY OF THE INVENTION

In order to achieve the above objects, a first configuration of the mobile terminal of the present invention characterized in comprising a storage unit which stores predetermined data, a setting unit which sets a delete condition for deleting the predetermined data and stores the delete condition in the storage unit, and a deleting unit which deletes the predetermined data from the storage unit according to the delete condition.

A second configuration of the mobile terminal of the present invention is characterized in that, in the first configuration, the setting unit sets time for deleting the predetermined data as the delete condition, and the deleting unit deletes the predetermined data when the time is reached.

A third configuration of the mobile terminal of the present invention is characterized in that, in the first configuration, the setting unit sets, as the delete condition, time from when operation to end the use of the mobile terminal is performed and, in the case in which operation to use the mobile terminal again is not performed before the time passes, the deleting unit deletes the predetermined data after the time passes.

A fourth configuration of the mobile terminal of the present invention is characterized in that, in the first configuration, the setting unit sets time from when the delete condition is set, as the delete condition, and the deleting unit deletes the predetermined data after the time passes.

A fifth configuration of the mobile terminal of the present invention is characterized in that, in the first configuration, the setting unit sets time from when the predetermined data is viewed, as the delete condition, and the deleting unit deletes the predetermined data after the time passes.

A sixth configuration of the mobile terminal of the present invention is characterized in that, in the first configuration, the predetermined data is data received by the mobile terminal, as the delete condition, the setting unit sets time from when the predetermined data is received or viewed, and the deleting unit deletes the predetermined data after the time passes.

A seventh configuration of the mobile terminal of the present invention is characterized in that, in the sixth configuration, the time is included in received data, and the setting unit sets the delete condition on the basis of the time included in the received data.

An eighth configuration of the mobile terminal of the present invention is characterized in that, in the first configuration, the setting unit sets a base station for communicating with the mobile terminal, as the delete condition, and the deleting unit deletes the predetermined data when the mobile terminal communicates with another base station which is different from the base station.

A ninth configuration of the mobile terminal of the present invention is characterized in that, in the first configuration, the setting unit sets, as the delete condition, time from when communication between a base station communicating with the mobile terminal and another base station different from the base station is started, and the deleting unit deletes the predetermined data after the time passes after the mobile terminal communicates with the other base station.

A tenth configuration of the mobile terminal of the present invention is characterized in that, in any of the first through ninth configurations, the predetermined data is part of the data stored in the storage unit, and the setting unit sets the predetermined data as the delete condition.

An eleventh configuration of the mobile terminal of the present invention is characterized in that, in any of the first through tenth configurations, the mobile terminal can communicate with a storage device which is connected to a network, the predetermined data is uploaded to the storage device via the network and thereby stored in the storage device, and the predetermined data can be downloaded from the storage device after the predetermined data is deleted.

A twelfth configuration of the mobile terminal of the present invention is characterized in, in the eleventh configuration, limiting the download of the predetermined data which is stored in the storage device, in accordance with the present time when download is performed.

According to the present invention, various delete conditions are set in the mobile terminal in advance, and, when the delete conditions are satisfied, the data is deleted by control performed by the mobile terminal. By allowing the mobile terminal to perform the control by itself instead of allowing the outside such as a network to perform the control, it is possible to reduce the risk that the information leaks out to a third person when the network cannot perform the control or during a period of time between when the terminal is lost and when the loss of the terminal is noticed. Moreover, data to be deleted is saved in another computer device by uploading the data onto, for example, a server on the network so that the data can be recovered, whereby leakage of the information from the mobile terminal can be prevented without hampering the convenience for the user.

### BRIEF DESCRIPTION OF THE DRAWINGS

FIG. 1 is a figure showing an example of a network configuration having a mobile terminal in embodiments of the present invention;

FIG. 2 is a configuration diagram of a function of the mobile terminal in the embodiments of the present invention;

FIG. 3 is a figure for explaining a first deletion processing of the mobile terminal in the embodiments of the present invention;

FIG. 4 is a figure showing an example of a time delete table;

FIG. 5 is a figure for explaining a second deletion processing of the mobile terminal in the embodiments of the present invention;

FIG. 6 is a figure showing an example of an unused timer delete table;

FIG. 7 is a figure for explaining a third deletion processing of the mobile terminal in the embodiments of the present invention;

FIG. 8 is a figure showing an example of a timer delete table;

FIG. 9 is a figure for explaining a fourth deletion processing of the mobile terminal in the embodiments of the present invention;

FIG. 10 is a figure showing an example of a received mail and a received mail timer delete table;

FIG. 11 is a figure for explaining a fifth deletion processing of the mobile terminal in the embodiments of the present invention;

FIG. 12 is a figure showing an example of a browse timer delete table;

FIG. 13 is a figure for explaining a sixth deletion processing of the mobile terminal in the embodiments of the present invention;

FIG. 14 is a figure showing an example of a base station information table and an outside-area timer delete table;

FIG. 15 is a figure for explaining processing of registering a base station to the base station information table;

FIG. 16 is a figure for explaining processing of registering an additional base station to or deleting a base station from the base station information table;

FIG. 17 is a figure for explaining another example of the processing of additionally registering a base station to the base station information table; and

FIG. 18 is a figure showing an example of a download information table.

### DESCRIPTION OF THE PREFERRED EMBODIMENTS

Hereinafter, embodiments of the present invention are described in detail with reference to the drawings. However, the embodiments are not to limit the technical scope of the present invention.

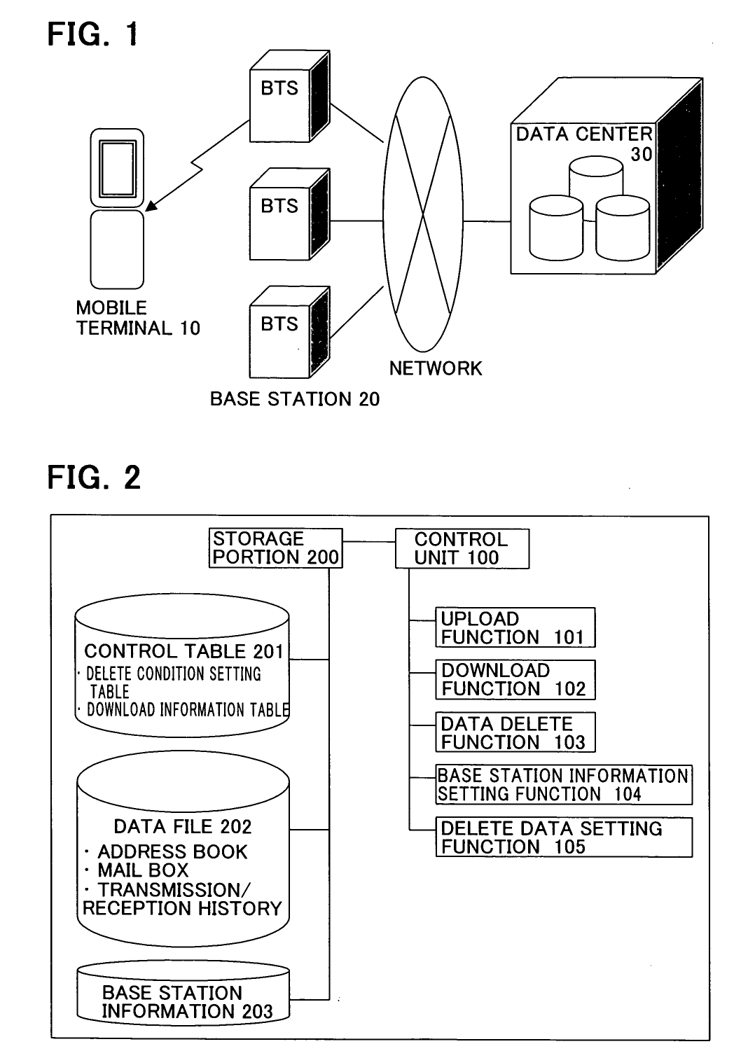

FIG. 1 is a figure showing an example of a network configuration having a mobile terminal in embodiments of the present invention. A mobile terminal 10 is, for example, a mobile telephone, and is connected to a wireless network via a wireless base station device 20 (BTS: Base Transceiver Station. Referred to simply as “base station” hereinafter). Further, a data center 30, which is managed by a mobile-service provider, is also connected to the wireless network. As described hereinbelow, the data center 30 can store data stored in the mobile telephone 10, as a backup.

FIG. 2 is a configuration diagram of a function of the mobile terminal in the embodiments of the present invention. A control unit 100 of the mobile telephone 10 is, for example, a processing unit such as a CPU, and realizes an upload function 101, download function 102, data delete function 103, base station information setting function 104, and delete data setting function 105 of the present embodiment by executing programs. A storage unit 200 is, for example, nonvolatile memory such as flash memory, and stores a control table 201, data file 202, base station information 203 and the like of the present embodiment. As described hereinbelow, the control table 201 has various delete setting tables such as a delete condition setting table, and the data file 202 has data such as the address book for storing mail addresses and phone numbers, sent and received mails, transmission/reception history of e-mails and phone calls, and the like. The base station information 203 is information for identifying a base station.

Hereinafter, deletion processing of the mobile terminal in the embodiments of the present invention is described. In the deletion processing of the embodiments of the present invention, data is deleted by control performed by the mobile terminal itself when various delete conditions that are set in advance in the mobile terminal are satisfied. By allowing the mobile terminal to perform the control of deleting data by itself instead of allowing the outside such as a network to perform the control, it is possible to reduce the risk that the information leaks out to a third person when the network cannot perform the control or during a period of time between when the terminal is lost and when the loss of the terminal is noticed. Moreover, data to be deleted is saved in another computer device by uploading the data onto, for example, a server on the network so that the data can be recovered, whereby leakage of the information from the mobile terminal can be prevented without hampering the convenience for the user. The deletion processing is performed by the data delete function 103 of the mobile terminal 10. Further, setting of delete conditions are performed by the delete data setting function 105.

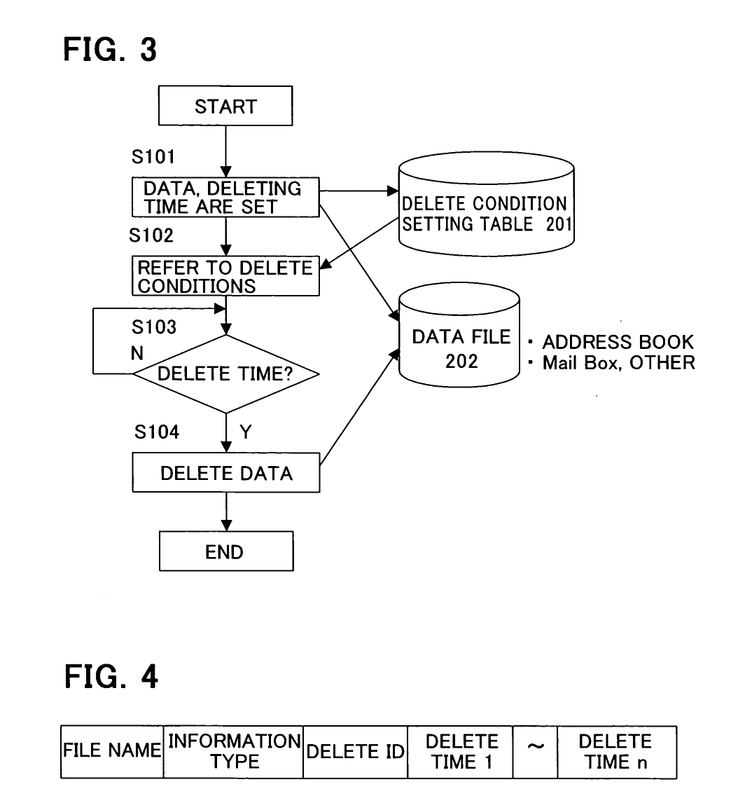

FIG. 3 is a figure for explaining a first deletion processing of the mobile terminal in the embodiments of the present invention. The first deletion processing is time deletion processing for deleting predetermined data stored in the mobile terminal 10 when a predetermined time, which is set in advance, is reached. Specifically, first of all, a time delete table in which data to be deleted and time for deleting the data are previously specified is set in a delete condition setting table by operation performed by a user (S101).

FIG. 4 is a figure showing an example of the time delete table. The time delete table has in formation on a file name of the data to be deleted, data type, delete ID, and at least one delete time. If the data to be deleted is the address book of a mail, the file name of the address book is set, thus the data type is “address book.” Each of the mail addresses registered in the address book can also be set as the data to be deleted. In this case, the file name is the mail address itself, thus the data type is “mail address.” Moreover, a mailbox which stores received mails and sent mails therein can also be set as the data to be deleted. By setting a mail box itself, the mails stored therein can be deleted. Only the received mails or only the sent mails can also be set as the data to be deleted. The delete ID is an ID for discriminating each of the delete condition setting tables, and can discriminate the types of deletion processing as well, which are disclosed in the present specification.

One or a plurality of delete times can be set. The immediacy of the delete timing differs depending on the type of data, thus it is made possible to set a plurality of delete times for each data item to be deleted. For example, a delete time for a certain mail address registered in the address book is set to 18:00 everyday, and a delete time for a mailbox is set to 12:00 and 18:00 everyday. By setting a plurality of delete times, the number of delete operations in a single day can be increased, thus the data stored in the mobile terminal 10 can be deleted at shorter intervals, whereby the risk of leakage of information upon the loss of the terminal can be reduced.

Returning to FIG. 3, when the time delete table is set in the delete condition setting table, the delete time and deletion target data (delete condition) that are set in the time delete table are referred (S102), and when the deleted time is reached (S103), the data which is the target of deletion is deleted at the delete time according to the time delete table (S104).

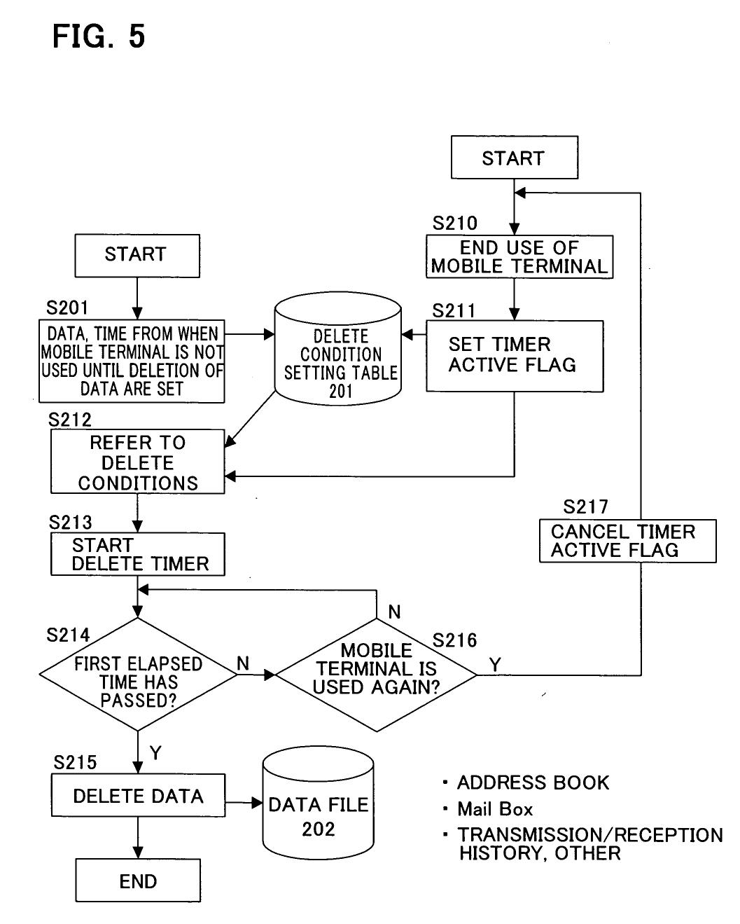

FIG. 5 is a figure for explaining a second deletion processing of the mobile terminal in the embodiments of the present invention. The second deletion processing is unused timer deletion processing for deleting the predetermined data stored in the mobile terminal 10 after a lapse of a predetermined time from an operation of ending the use of the mobile terminal. Specifically, first of all, the unused timer delete table in which data to be deleted and time before deletion are previously specified is set in the delete condition setting table by operation performed by the user (S201).

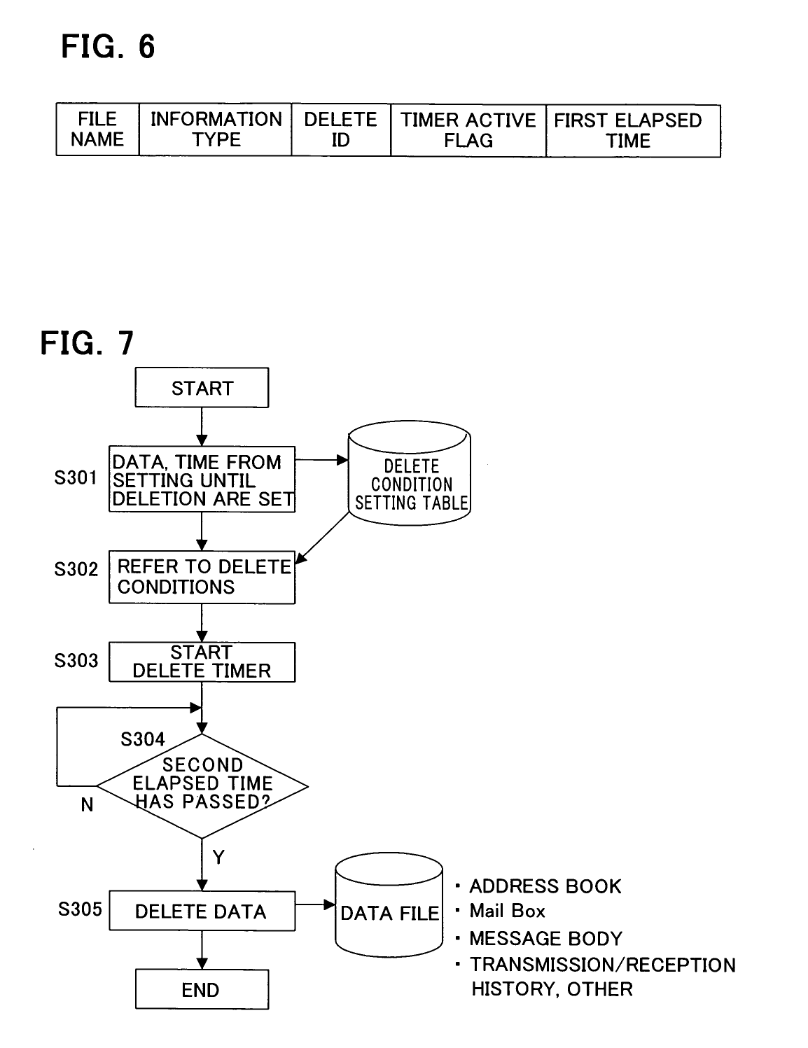

FIG. 6 is a figure showing an example of the unused timer delete table. As in FIG. 4, the unused timer delete table has a data file name for specifying data to be deleted, data type, delete ID, first elapsed time which is an elapsed time from when the operation of ending the use of the terminal is performed, and a timer active flag. The timer active flag is a flag which is set when the operation of ending the use of the terminal is performed, and timer operation is started by setting the flag.

Returning to FIG. 5, when the operation of ending the use of the mobile terminal is performed (S210), the timer active flag is set (S211). The operation of ending the use of the terminal is an operation of folding and closing the mobile telephone if the mobile terminal is a folding mobile telephone, and, when the mobile telephone is in the closed state, the timer active flag is set.

When the timer active flag is set, the delete conditions that are set in the unused timer delete table, that is, the first elapsed time and the deletion target data are referred (S212), and the timer operation is started (S213). When the first elapsed time passes without using the mobile terminal again, (S214), the data which is the target of deletion is deleted at the first elapsed time according to the unused timer delete table (S215). If an operation of using the mobile terminal again is detected by the mobile terminal being opened from the closed state before the first elapse time passes (S216), the timer active flag is canceled, and the timer operation is reset (S217).

FIG. 7 is a figure for explaining a third deletion processing of the mobile terminal in the embodiments of the present invention. The third deletion processing is timer deletion processing for deleting the predetermined data stored in the mobile terminal 10 after a predetermined time passes from the end of operation for setting a time until deletion of the data is performed. Specifically, first of all, a timer delete table in which are previously specified data to be deleted and time until deletion is performed is set in the delete condition setting table by operation performed by the user (S301).

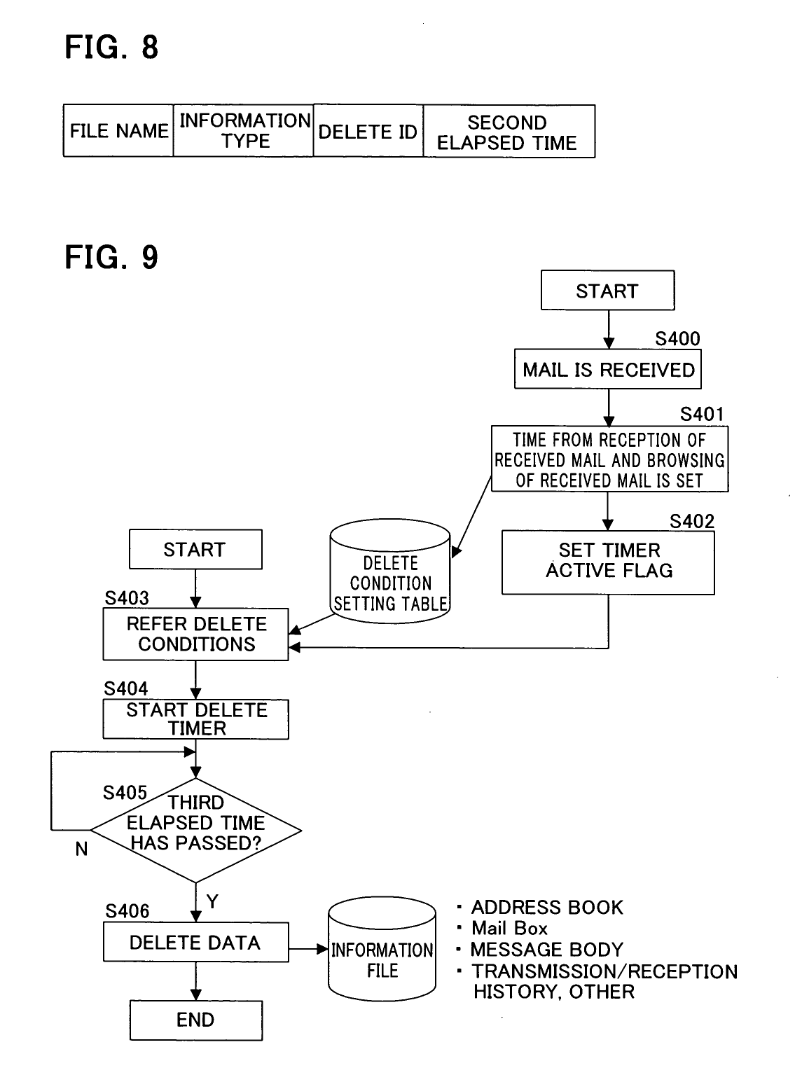

FIG. 8 is a figure showing an example of the timer delete table. As in the unused timer delete table of FIG. 6, the timer delete table has a data file name for specifying data to be deleted, data type, delete ID, second elapsed time which is an elapsed time from when the operation of ending the setting is performed, and the timer active flag. The timer active flag is a flag which is set when the operation of ending the setting is performed, and timer operation is started by setting the flag.

Returning to FIG. 7, when the timer active flag in the timer delete table is set, the delete conditions that are set in the timer delete table, that is, the second elapsed time and the deletion target data are referred (S302), and the timer operation is started (S303). When the second elapsed time passes (S304), the data which is the target of deletion is deleted at the second elapsed time according to the timer delete table (S305).

FIG. 9 is a figure for explaining a fourth deletion processing of the mobile terminal in the embodiments of the present invention. The fourth deletion processing is received mail deletion processing to delete a received e-mail, and deletes received mails stored in the mobile terminal 10 after a predetermined time, which is set in the received e-mail in advance, passes from a received time or referred time in accordance with the predetermined time. Specifically, when a mail is received (S400), a received mail timer delete table in which are specified the received mail and a predetermined time until deletion is performed is set in the delete condition setting table on the basis of the predetermined table until deletion is performed, which is set in the received mail (S401).

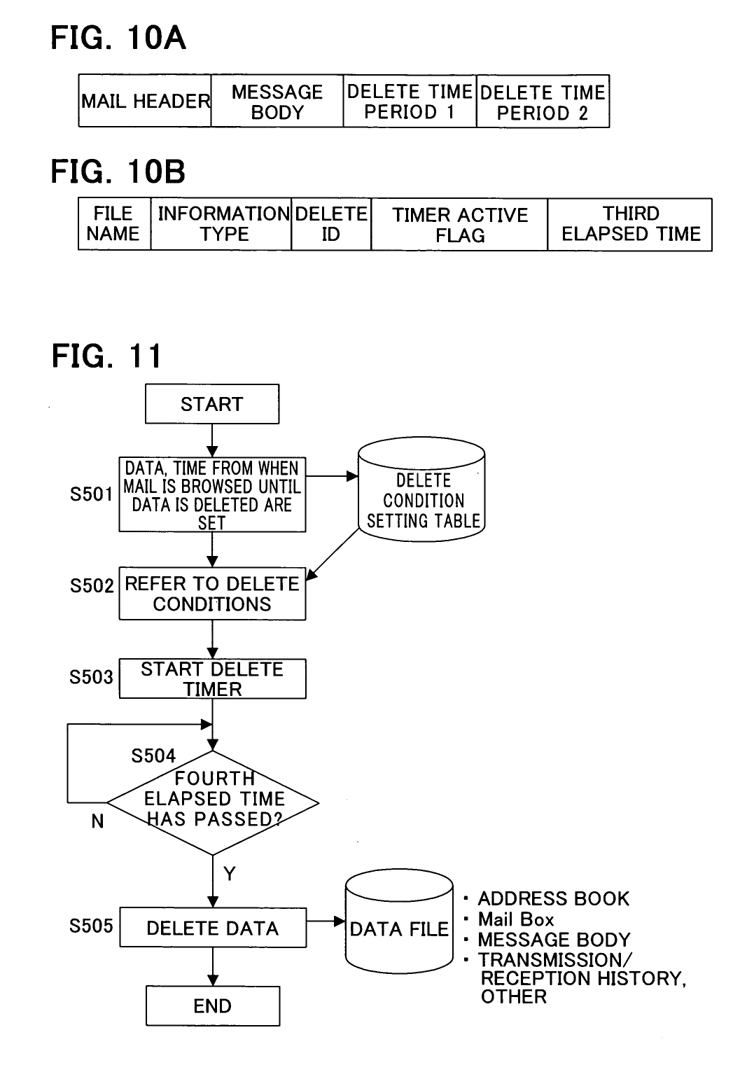

FIG. 10 is a figure showing an example of the received mail and the received mail timer delete table. FIG. 10(a) is a figure showing a data configuration of the received mail, time until deletion is performed (delete time period) is set, following a mail header and message body. A delete time period 1 is, for example, a period of time between a received time and deleting time, and a delete time period 2 is a period of time between a browsed time and a deleting time. A mail sender specifies either one of the delete time periods and sends a mail. FIG. 10(b) is a configuration of the received mail timer delete table, and has a data file name of a mail to be deleted, data type, delete ID, a third elapsed time which is an elapsed time from the received time and the browsed time, and the timer active flag. The timer active flag is a flag which is set when the reception operation and browsing operation are performed, and timer operation is started by setting the flag.

Returning to FIG. 9, when the timer active flag of the received mail timer delete table is set (S402), the delete conditions set in the timer delete table, that is, the third elapsed time and deletion target mail are referred (S403), and the timer operation is started on the basis of the reception operation or referring operation (S404). Then, when the third elapsed time passes (S405), the mail data which is the target of deletion is deleted at the third elapsed time in accordance with the timer delete table (S406).

FIG. 11 is a figure for explaining a fifth deletion processing of the mobile terminal in the embodiments of the present invention. The fifth deletion processing is browse timer deletion processing for deleting predetermined data stored in the mobile terminal 10 after a lapse of a predetermined time from when the data is browsed. Specifically, first of all, a browse timer delete table in which are previously specified data to be deleted and time until deletion is performed is set in the delete condition setting table by operation performed by the user (S501).

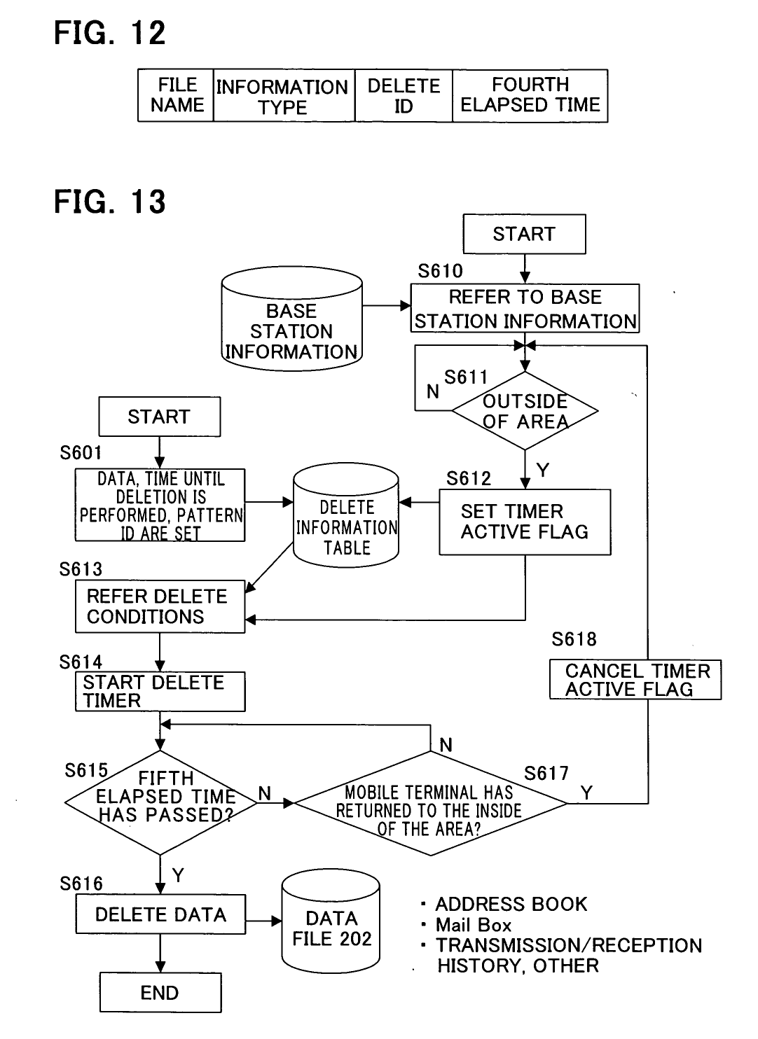

FIG. 12 is a figure showing an example of the browse timer delete table. As in the unused timer delete table of FIG. 6, the browse timer delete table has a data file name for specifying data to be deleted, data type, delete ID, fourth elapsed time which is an elapsed time from when a browsing operation is performed, and the timer active flag. The timer active flag is a flag which is set when the browsing operation is performed, and timer operation is started by setting the flag.

Returning to FIG. 11, when the timer active flag of the browse timer delete table is set by performing browsing, a second time which is set in the browse timer delete table is referred (S502), and the timer operation is started (S503). Then, when the fourth elapsed time passes (S504), the data which is the target of deletion is deleted at the fourth elapsed time in accordance with the browse timer delete table (S505).

FIG. 13 is a figure for explaining a sixth deletion processing of the mobile terminal in the embodiments of the present invention. The sixth deletion processing is outside-area timer delete processing for deleting the predetermined data after a predetermined time passes from when it is recognized that the mobile terminal is outside of a previously set base station area. Specifically, a pattern ID that corresponds to at least one base station is set in a base station information table, and the outside-area timer delete table in which data to be deleted, time until deletion is performed, and the pattern ID are specified is set in the delete condition setting table (S601).

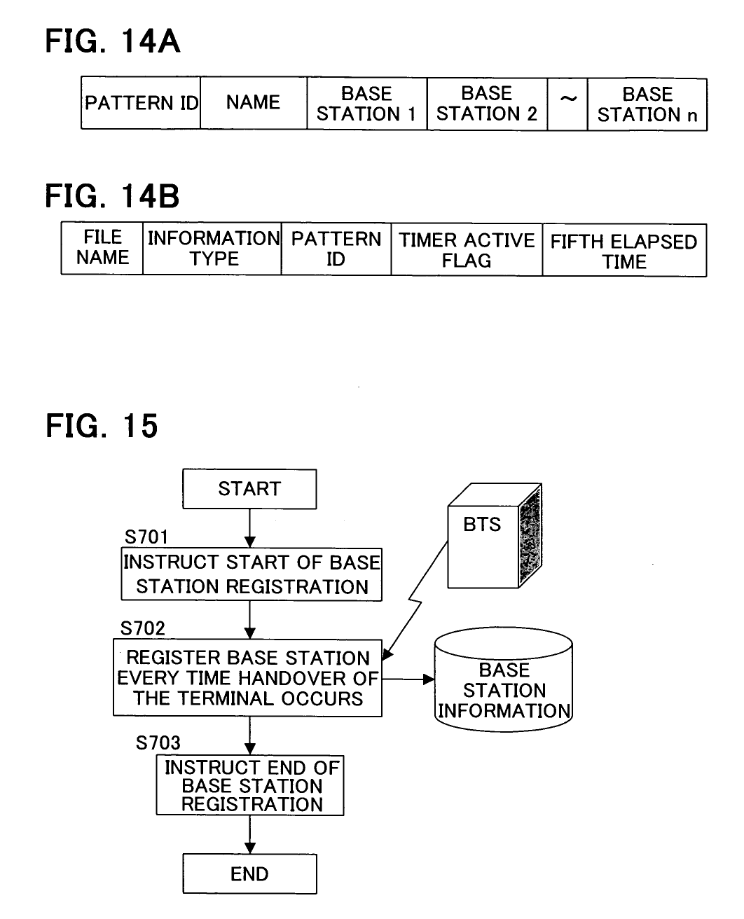

FIG. 14 is a figure showing an example of the base station information table and the outside-area timer delete table. The base station information table shown in FIG. 14(a) has a pattern ID and one or a plurality of base station information items, and may preferably be given a name that corresponds to the pattern ID. By giving a name such as “commute” if the pattern ID corresponds to a base station which presents in a commuter route, or “business trip” if the pattern ID corresponds to a base station which presents in a trip destination, the user can easily select a pattern ID as usage. The outside-area timer delete table shown in FIG. 14(b) has a data file name for specifying data to be deleted, data type, pattern ID, fifth elapsed time which is an elapsed time from when outside-area recognition is performed, and a timer active flag. The timer active flag is a flag which is set when the outside-area recognition is performed, and timer operation is started by setting the flag.

Returning to FIG. 13, the mobile terminal refers to the base station information corresponding to the pattern ID which is set in the outside-area timer delete table (S610), and, if it is judged that the mobile terminal is located outside the area, (S611), the timer active flag is set (S612).

When the timer active flag is set, the fifth elapsed time which is set in the outside-area timer delete table is referred (S613), and the timer operation is started (S614). If the fifth elapsed time passes when the mobile terminal is not returned to the inside of the registered base station area (S615), the data which is the target of deletion is deleted at the fifth elapsed time in accordance with the outside-area timer delete table (S616). If it is judged that the mobile terminal is returned to the inside of the area before the fifth elapsed time passes (S617), the timer active flag is canceled, and the timer operation is reset (S618).

FIG. 15 is a figure for explaining processing of registering a base station to the base station information table. The base station registration processing (and deletion processing) is performed by the base station information setting function 104 of the control unit 100. When start of the base station registration processing is instructed (S701), the information of a base station with which the mobile terminal is presently communicated is acquired, thereby registering the information to the base station information table, and a new base station is registered every time handover occurs along with movement of the mobile terminal (S702). When the mobile terminal is moved to the inside of all areas of base stations to be registered, and when these base stations are registered, completion of the registration processing is instructed (S703).

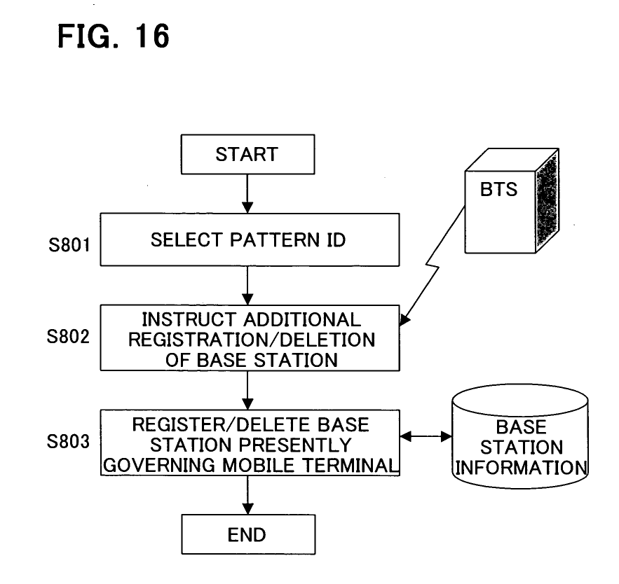

FIG. 16 is a figure for explaining processing of registering an additional base station to or deleting a base station from the base station information table. A pattern ID of the base station information table is selected (S801), and addition or deletion is instructed (S802). Accordingly, abase station which governs an area in which the mobile terminal presently exists is additionally registered or deleted (S803).

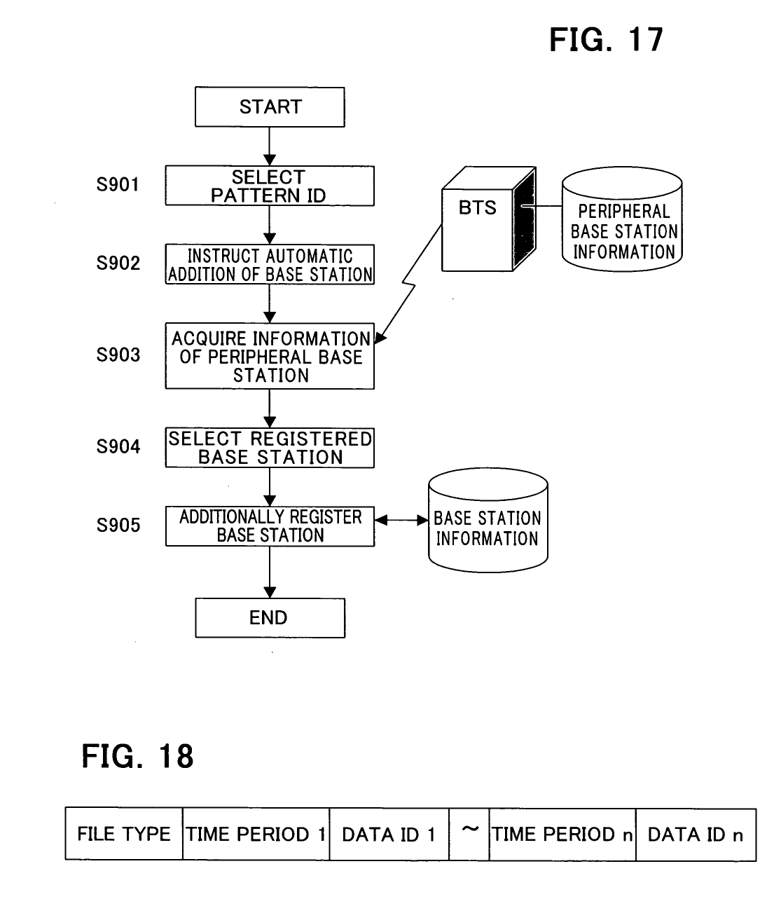

FIG. 17 is a figure for explaining another example of the processing of additionally registering a base station to the base station information table. A pattern ID of the base station information table is selected (S901), addition of a base station is instructed (S902), and peripheral base station information is acquired from the base station which governs an area in which the mobile terminal presently exists (S903). The peripheral base station information is information about a base station in the vicinity of the base station of the present area. By the user selecting any base station (S904), the base station is additionally registered (S905).

The data to be deleted in each processing described above is preferably recoverable according to need so that the convenience for the user is not hampered. Therefore, all the data stored in the mobile terminal 10 is automatically uploaded onto the data center 30 in advance before deleting the data. The timing of uploading the data from the mobile terminal 10 onto the data center 30 is the timing of saving each data item to the storage unit 200 inside the mobile terminal 10. When a connection with the data center via a base station cannot be made (in the case where the terminal is outside the range), the upload processing is suspended, and the uploading is performed once communication is made possible. For example, when each data item has a flag indicating whether uploading is completed or not, and the mobile terminal 10 has new data saved therein, data in which a flag indicating completed uploading is not set is uploaded along with the newly saved data. Uploading of data is performed by the upload function 101 of the control unit 100.

By uploading all the data onto the data center, even if the data is deleted from the mobile terminal, necessary data can be downloaded by accessing the data center, whereby the data can be recovered to the mobile terminal. It is preferred that data such as mail addresses and phone numbers that are of greater risk of information leakage being deleted, from the perspective of reducing the risk of information leakage. However, in the case of frequently-used data that is not recoverable after being deleted, the convenience for the user is significantly reduced. Therefore, by saving the data to be deleted as a backup to another computer device (the data center of a network in the above mentioned example) in advance so that the data can be downloaded, the convenience for the user can be maintained, and information leakage due to deletion of the data can be prevented. Downloading the data is performed by the download function 102 of the control unit 100.

When accessing the data center in order to download the data, authentication of the user needs to be performed. However, when uploading the data, authentication of the user is not necessarily performed. If authentication is requested to be carried out every time uploading is performed, operation is performed frequently by the user, and the information is not to be disclosed.

Data to be downloaded may be set as the condition. For example, in the case of downloading a mail address, when an address book for mail addresses for business purposes, and an address book for mail addresses for private purposes are created, and are uploaded on the data center, when downloading the address books during the midday work hours, only the business address book can be downloaded, and, when downloading the address books during a period of time in the evening after work, only the private address book can be downloaded. Information regarding the limits of the data to be downloaded depending on the time period is set by, for example, a download information table. In this manner, by limiting downloading of data saved in the data center in accordance with the present time, the possibility that unnecessary data is downloaded to the mobile terminal can be reduced, whereby information inside the mobile terminal can be restricted to the minimum necessary, and the risk of information leakage can be further reduced.

FIG. 18 is a figure showing an example of the download information table. An address book is specified as a file type, an ID of the business address book is set in a time period 1, and an ID of the private address book is set in a time period 2. When downloading the address books by accessing the data center in the case where the address books are deleted, the address book which is set in the time periods having a downloading time is selectively downloaded.

A device for saving the data to be deleted from the mobile terminal, as a backup, is not limited to the data center on the network, and may be, for example, a computer device on the network to which another server device on the Internet can always access.

What is claimed is:

1. A mobile terminal, comprising:
a storage unit which stores predetermined data;
a setting unit which sets a delete condition for deleting the predetermined data and stores the delete condition in the storage unit; and
a deleting unit which deletes the predetermined data from the storage unit according to the delete condition.

2. The mobile terminal according to claim 1, wherein the setting unit sets time for deleting the predetermined data as the delete condition, and the deleting unit deletes the predetermined data when the time is reached.

3. The mobile terminal according to claim 1, wherein the setting unit sets, as the delete condition, time from when operation to end the use of the mobile terminal is performed, and, in the case in which operation to use the mobile terminal again is not performed before the time passes, the deleting unit deletes the predetermined data after the time passes.

4. The mobile terminal according to claim 1, wherein the setting unit sets time from when the delete condition is set, as the delete condition, and the deleting unit deletes the predetermined data after the time passes.

5. The mobile terminal according to claim 1, wherein the setting unit sets time from when the predetermined data is viewed, as the delete condition, and the deleting unit deletes the predetermined data after the time passes.

6. The mobile terminal according to claim 1, wherein,
the predetermined data is data received by the mobile terminal;
the setting unit sets time from when the predetermined data is received or viewed, as the delete condition; and
the deleting unit deletes the predetermined data after the time passes.

7. The mobile terminal according to claim 6, wherein the time is included in received data, and the setting unit sets the delete condition on the basis of the time included in the received data.

8. The mobile terminal according to claim 1, wherein the setting unit sets a base station for communicating with the mobile terminal, as the delete condition, and the deleting unit deletes the predetermined data when the mobile terminal communicates with another base station which is different from the base station.

9. The mobile terminal according to claim 1, wherein the setting unit sets, as the delete condition, time from when communication between a base station communicating with the mobile terminal and another base station different from the base station is started, and the deleting unit deletes the predetermined data after the time passes after the mobile terminal communicates with the other base station.

10. The mobile terminal according to claim 1, wherein:
the predetermined data is part of the data stored in the storage unit; and
the setting unit sets the predetermined data as the delete condition.

11. The mobile terminal according to claim 1, wherein:
the mobile terminal can communicate with a storage device which is connected to a network;
the predetermined data is uploaded to the storage device via the network and thereby stored in the storage device; and
the predetermined data can be downloaded from the storage device after the predetermined data is deleted.

12. The mobile terminal according to claim 11, wherein download of the predetermined data which is stored in the storage device is limited in accordance with the present time when download is performed.
